(19) United States
(12) Patent Application Publication
(10) Pub. No.: US 2024/0111259 A1
(43) Pub. Date: Apr. 4, 2024

(54) METHOD FOR TRAINING AN AGENT

(71) Applicant: Robert Bosch GmbH, Stuttgart (DE)

(72) Inventors: Jelle van den Broek, Heiloo (NL); Herke van Hoof, Diemen (NL); Jan Guenter Woehlke, Leonberg (DE)

(21) Appl. No.: 18/467,351

(22) Filed: Sep. 14, 2023

(30) Foreign Application Priority Data
Sep. 19, 2022 (DE) 10 2022 209 845.5

(51) Int. Cl. G05B 13/02; G06N 3/092

(52) U.S. Cl. CPC G05B 13/027; G06N 3/092

(57) ABSTRACT

A method for training an agent having a planning component. The method includes carrying out a plurality of control passes, and training the planning component to reduce a loss that includes, for each of a plurality of coarse-scale state transitions occurring in the control passes from a coarse-scale state to a coarse-scale successor state, an auxiliary loss that represents a deviation between a value outputted by the planning component for the coarse-scale state and the sum of a reward received for the coarse-scale state transition and at least a portion of the value of the coarse-scale successor state.

### CROSS REFERENCE

The present application claims the benefit under 35 U.S.C. § 119 of German Patent Application No. DE 10 2022 209 845.5 filed on Sep. 19, 2022, which is expressly incorporated herein by reference in its entirety.

### FIELD

The present invention relates to methods for training an agent.

### BACKGROUND INFORMATION

Reinforcement learning (RL) is a machine learning paradigm that enables an agent, e.g. a robot, to learn to perform a desired behavior relative to a task specification, e.g., what control measures to actuate to reach a destination in a robot navigation scenario.

Architectures that combine planning with reinforcement learning can be used effectively for decision problems (e.g., controlling a vehicle or a robot based on sensory inputs). They enable the incorporation of prior problem knowledge (e.g., a map of the environment) and can enable generalization across different problem instances (e.g., different environment layouts) through the planning part, while retaining the ability to deal with high-dimensional observations and unknown dynamics through the RL part.

The paper “Value Propagation Networks” by Nardelli et al., 2019 (https://arxiv.org/pdf/1805.11199.pdf), hereinafter referred to as Reference 1, describes an architecture with a planning module containing a neural network that, given a discrete map (image) of the environment and a target map, outputs a propagation map and a reward map that are used for the iterative planning of a value map. For the action selection and training, an actor-critic control strategy is added to the planning part, which receives (excerpts from) the value map as input. By back-propagating the gradients that result from the actor-critic losses, including through the planning part, the entire architecture is trained throughout. The VProp (for “Value Propagation”) or the variant MVProp (for “Max-Propagation”) also described in the paper is proposed for discrete state and action space problems, because a discretized map is required as input and the highest-value state from a neighborhood in the planned value map must be selected as action.

The paper “Addressing Function Approximation Error in Actor-Critic Methods” by Fujimoto et al, 2018 (https://arxiv.org/pdf/1802.09477.pdf), hereinafter referred to as reference 2, describes an off-policy actor-critic algorithm referred to as TD3 (Twin Delayed Deep Deterministic Policy Gradient).

Training methods for agents that further improve agent performance, especially in special environments, e.g., with different terrain types, are desirable.

### SUMMARY

According to various embodiments of the present invention, a method is provided for training an agent that includes performing a plurality of control passes, wherein in each control pass:
a planning component receives a representation of an environment containing layout information about the environment, the environment being divided into coarse-scale (or “high-level”) states according to a grid of coarse-scale states such that each (“fine-scale” or “low-level”) state that can be taken in the environment is in a coarse-scale state together with a plurality of other states that can be taken in the environment;
a neural network of the planning component derives information about the traversability of states in the environment from the representation of the environment,
the planning component assigns a value to each coarse-scale state based on the traversability information and preliminary reward information for the coarse-scale state; and
(for the respective controlling) in each of a plurality of states reached in the environment by the agent, an actor neural network ascertains an action from an indication of the state and from values ascertained by the planning component for coarse-scale states in a neighborhood that contains the coarse-scale state in which the state is located and the coarse-scale states adjacent thereto; and

the planning component being trained to reduce an auxiliary loss that contains, for each of a plurality of coarse-scale state transitions caused by the ascertained actions from a coarse-scale state to a coarse-scale successor state, a loss representing a deviation between a value outputted by the planning component for the coarse-scale state and the sum of a reward received for the coarse-scale state transition and at least a portion of the value of the coarse-scale successor state.

Auxiliary loss, also referred to as planning component loss or, in the example embodiment of the present invention based on MVProp described below, MVProp auxiliary loss, improves the training in that better performance of the trained agent (higher success rate for completing a task and lower variance in performance between agents trained in independent training processes) when applied to a decision process for a controlling, such as a robot navigation task. In particular, the auxiliary loss for training the planning component (also referred to herein as the planning module) enables high success rates in application scenarios with different terrain types that require learning a diversified propagation factor map for the environment.

The (fine-scale) states that can be taken in the environment are, for example, positions (e.g., in the case of a navigation task in which the environment is simply a 2D or 3D environment of positions). However, the state space can also be more complicated (e.g., may include orientations), such that each state that can be taken in the environment has more than one position in the environment (e.g., a pair of position and orientation, e.g., when controlling a robotic arm). Whether and how well a state can be traversed (i.e., the information about the traversability of a state, e.g. in the form of a propagation factor) can be understood in such a way that the state (e.g., a certain orientation at a certain position) can be assumed and, starting from this state, another state can also be reached again. Here, with respect to (coarse-scale) states, intermediate values (e.g. for the propagation factors) can result (e.g. between 0 and 1) that express how likely such a transition is (e.g. the risk of getting stuck in muddy terrain) or with what relative speed (e.g. slowing down of the movement in sandy terrain) the state can be traversed.

The plurality of states reached in the environment by the agent starting from an output of the neural actor network need not be all the states reached by the agent (in the control pass). In contrast, actions can be ascertained randomly for some of the states for an exploration. The coarse-scale state transitions caused by these actions can also be included in the loss for the training of the planning component. In other words, each state transition is due to an action of the agent, which is either selected according to the learned policy (strategy), i.e. based on the output of the actor network, or is just randomly selected for exploration purposes.

For example, the layout information includes information about the subsurface of the environment, obstacles in the environment, and/or one or more destinations in the environment.

The formulation “at least a portion of the value of the coarse-scale successor state” is to be understood to mean that the value of the coarse-scale successor state as it occurs in summation can be discounted as is standard in reinforcement learning (i.e., weighted by a discount factor standardly (as below) designated Υ, less than 1).

Various exemplary embodiments of the present invention are given below.

Embodiment 1 is a method for training an agent as described above.

Embodiment 2 is a method according to embodiment 1, wherein the planning component is trained to reduce an overall loss that includes, in addition to the auxiliary loss, an actor loss that penalizes when the neural actor network selects actions that a critic network evaluates as low.

Thus, in the training of the planning component the requirements for high performance of the controlling are taken into account by the actions outputted by the actor network.

Embodiment 3 is a method according to embodiment 1, wherein the planning component is trained to reduce an overall loss, which in addition to the auxiliary loss includes a critic loss that penalizes deviations of evaluations, provided by a critic network, of state-action pairs from evaluations that include sums of the rewards actually obtained by performing the actions of the state-action pairs in the states of the state-action pairs, and discounted evaluations, provided by a critic network, of successor state-successor action pairs, the successor actions to be used for the successor states being determined with the aid of the actor network for the successor states.

Thus, in the training of the planning component, the requirements for high accuracy of the critic network (or critic networks if, for example, a target critic network is also used) are taken into account.

Embodiment 4 is a method according to embodiment 1, wherein the planning component is trained to reduce an overall loss that includes, in addition to the auxiliary loss, an actor loss that penalizes when the neural actor network selects actions that a critic network gives a low evaluation, and a critic loss that penalizes deviations of evaluations, provided by a critic network, of state-action pairs from evaluations that include sums of the rewards actually obtained by performing the actions of the state-action pairs in the states of the state-action pairs, and discounted evaluations, provided by a critic network, of successor state-successor action pairs, the successor actions to be used for the successor states being determined with the aid of the actor network for the successor states.

Thus, in the training of the planning component both the requirements for high performance of the controlling through the actions outputted by the actor network and the requirements for high accuracy of the critic network are taken into account.

Embodiment 5 is a method according to one of the embodiments 1 to 4, wherein the layout information includes information about the location of different terrain types in the environment, and the representation for each terrain type includes a map having binary types that indicates, for each of a plurality of locations in the environment, whether the terrain type is present at the location.

This improves performance for application scenarios with a plurality of terrain types compared to using a single channel for all terrain types.

Embodiment 6 is a method according to one of embodiments 1 to 5, wherein the values ascertained by the planning component for the neighborhood of coarse-scale states are normalized with respect to the mean value of these ascertained values and the standard deviation of these ascertained values.

This improves the performance of the trained agent for environments that are larger than those that occur in the training.

Embodiment 7 is a control device set up to carry out a method according to one of embodiments 1 to 6.

Embodiment 8 is a computer program having instructions that, when executed by a processor, cause the processor to carry out a method according to one of embodiments 1 to 6.

Embodiment 9 is a computer-readable medium that stores instructions that, when executed by a processor, cause the processor to carry out a method according to one of embodiments 1 to 6.

In the figures, similar reference signs generally refer to the same parts in all the different views. The figures are not necessarily to scale, the emphasis being instead generally on illustrating the principles of the present invention. In the following description, various aspects of the present invention are described with reference to the figures.

### BRIEF DESCRIPTION OF THE DRAWINGS

FIG. 1 shows a control scenario.

FIG. 2 shows an architecture for learning a control strategy according to a specific example embodiment of the present invention.

FIG. 3 shows a flow diagram representing a method for training an agent according to a specific example embodiment of the present invention.

### DETAILED DESCRIPTION OF EXAMPLE EMBODIMENTS

The following detailed description refers to the figures, which for the purpose of explanation show specific details and aspects of the present disclosure in which the present invention may be carried out. Other aspects may be used, and structural, logical, and electrical changes may be made, without departing from the scope of protection of the present invention. The various aspects of the present disclosure are not necessarily mutually exclusive, as some aspects of the present disclosure may be combined with one or more other aspects of the present disclosure to form new aspects.

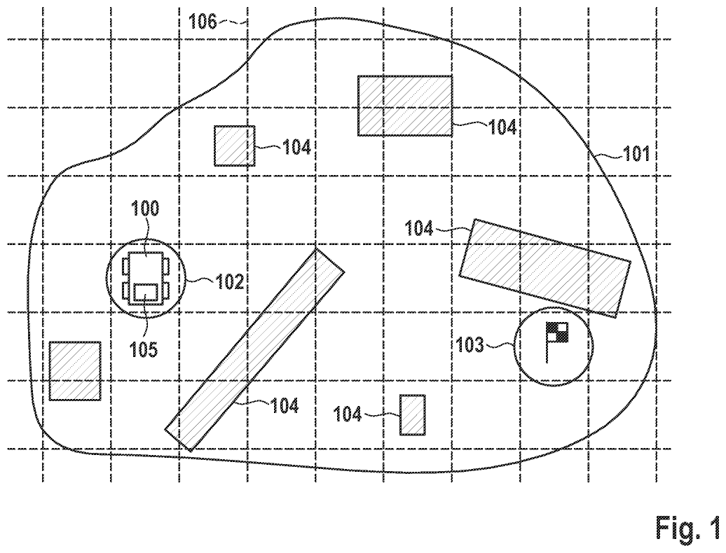

Various examples are described in more detail below. FIG. 1 shows a control scenario.

A controlled object 100 (e.g. a robot or a vehicle) is located in an environment 101. The controlled object 100 has a start position 102 and is supposed to reach a destination position 103. There are obstacles 104 in the environment 101 that are to be traveled around by controlled object 100. For example, the obstacles are not to be passed by controlled object 100 (e.g. walls, trees or rocks), or are to be avoided because the agent would damage or injure them (e.g. pedestrians).

The controlled object 100 is controlled by a control device 105 (where control device 105 may be located in the controlled object 100 or may be provided separately from it, i.e. the controlled object may be remotely controlled). In the example scenario of FIG. 1, the objective is for control device 105 to control controlled object 100 to navigate environment 101 from start position 102 to destination position 103. For example, controlled object 100 is an autonomous vehicle, but can also be a robot with legs or tracks or some other type of drive system (e.g., a deep-sea or Mars rover).

Moreover, the embodiments are not limited to the scenario in which a controlled object such as a robot (as a whole) is to be moved between the positions 102, 103, but may also be used, for example, to control a robot arm whose end effector is to be moved between the positions 102, 103 (without running into obstacles 104), etc.

Accordingly, in the following, terms such as robot, vehicle, machine, etc., are used as examples of the object to be controlled or of the computer-controlled system (e.g. a robot with objects in its workspace). The approaches described here can be used with various types of computer-controlled machines such as robots or vehicles and others. The general term “agent” is also used below to refer in particular to all types of physical systems that can be controlled using the approaches described below. However, the approaches described below can be applied to any type of agent (e.g., including an agent that is only simulated and does not physically exist).

In the ideal case, control device 105 has learned a control strategy that allows it to successfully control the controlled object 100 (from the start position 102 to the destination position 103 without meeting obstacles 104) for any scenarios (i.e. environments, start and destination positions) that the control device 105 has not yet encountered (during training), i.e. to select an action (here, movement in the 2D environment) for each position. Mathematically, this can be formulated as a Markov decision process.

According to various embodiments, a control strategy is trained together with a plan module using reinforcement learning.

By combining a planning algorithm with a reinforcement learning algorithm, such as TD3 (Twin Delayed Deep Deterministic Policy Gradient), efficient learning can be achieved by combining the advantages of both approaches. Neural networks are able to learn approximations of the value function and the dynamics of an environment 101. These approximations can also be used to approximate planning operations such as value iteration. Neural networks trained for the approximation of these planning operations are called differentiable planning modules. These modules are fully differentiable because the modules are neural networks. Therefore, these models can be fully trained using reinforcement learning.

MVProp (Max Value Propagation) is an example of such a differentiable planning module. It mimics a value iteration using a propagation map and a reward map, and assigns a propagation factor and a reward factor to each state. The propagation factor p represents how well a state propagates (i.e. how well the agent can traverse the state): if a state does not propagate at all because it is an end state 103 or it corresponds to an obstacle 104 (i.e. it cannot be taken by the particular robotic device), the propagation factor should be close to zero. If, on the other hand, the state propagates (i.e. can be taken (and thus also traversed) by the agent, the propagation factor should be close to 1. The propagation map models the transition function between two states. The reward factor represents the reward for entering a state and models the reward function. The value ν (in the sense of a “usefulness” for reaching the relevant destination; this can be viewed as the expected return of the state) of a state (indexed by a pair of indices ij) is iteratively (indexed by k) ascertained using the reward factor r̅ (which can be regarded as preliminary (or prior) reward information for the state) and the propagation factor p and a max pooling operation in a neighborhood [symbol] (z) of the state according to

$${v}_{ij}^{0} = {\overline{r}}_{ij} \qquad ( 1 )$$

$${v}_{ij}^{k} = max ( {v}_{ij}^{k - 1} , {max}_{{i}^{′} , {j}^{′} ∈ 𝒩 ( i , j )} ( {\overline{r}}_{ij} + {p}_{ij} ( {v}_{{i}^{′} {j}^{′}}^{( k - 1 )} - {\overline{r}}_{ij} ) ) ) \qquad ( 2 )$$

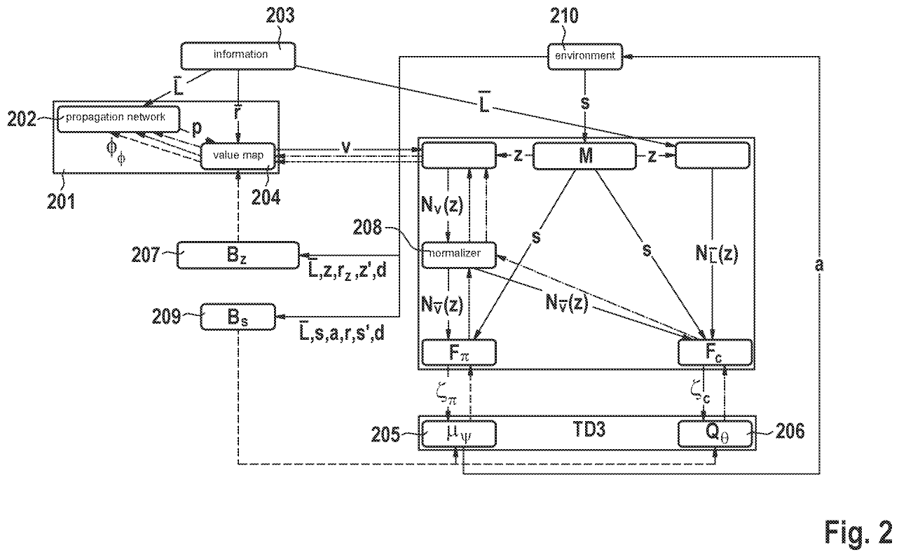

According to various embodiments, the planning module, here MVProp, is trained together with an actor-critic RL method. This is explained in more detail below with reference to FIG. 2.

FIG. 2 illustrates an architecture for learning a control strategy implemented by, for example, the control device 105.

As explained above, the architecture includes a planning module (here, MvProp) 201 with a neural network (referred to as a propagation network) 202 that is to be trained to ascertain, from feature information (or layout information) L̅ of the environment 101 (which is part of information 203 about the environment (e.g. an image of the environment)), a propagation map containing the propagation factor p for each state z. From the propagation map, the planning module 201 then ascertains a value map v according to equations (1) and (2), which for each state z obtains the value

$${Φ ( {\overline{L}}_{f} )}_{z} = {v}_{z}$$

of the state. For this purpose, planning module 201 (according to (1) and (2)) uses the reward factors r̅given by the information 203 about the environment.

Here, the states z refer to coarse-scale (or “abstract” or “high-level”) states of a coarse-scale planning on a coarse, discrete (map) representation of the environment 101. For example, the coarse, discrete representation of the environment is a grid 106 (shown as dashed lines in FIG. 1), where each tile of the grid 106 is a state of the coarse representation of the environment. An actor 205 and a critic 206, on the other hand, operate on more precise states (“fine-scale states”), designated s. Reinforcement learning thus occurs on a practically “continuous” scale (e.g. up to computational or number representation accuracy), i.e. on a much finer representation. For example, for an autonomous driving scenario, the tiles of the grid 106 are 10 meters×10 meters, while the accuracy of the low scale is centimeters, millimeters, or even less.

According to various embodiments, items of feature information L are divided into binary feature maps for each feature type, i.e. for example a bitmap indicating for each state whether the state contains an obstacle (i.e. is not passable) and another bitmap indicating for each state whether the state is a destination state. These bitmaps together are referred to as a split feature layout L̅_{ƒ}. The function that converts L̅ to L̅_{ƒ} is designated D. Each bitmap is routed to a separate channel of the propagation network 202 to generate the propagation map. The reward map with the reward factors r̅ is derived from information about the positions of the destination states contained in L̅_{ƒ} are contained.

To train the planning module, the transitions between abstract states (from control passes) are stored in a replay buffer 207 for the abstract states, denoted by B_{z}. This replay buffer 207 stores tuples of layout information, abstract state, abstract reward, next abstract state (i.e. abstract successor state), and the information as to whether the control pass ends with this transition: (L̅, z, r_{z}, z′, d).

The sum of (fine-scale) rewards (i.e. rewards from state transitions s to s′) obtained by the transition from z to z′ (which, because of the coarser grid, may require many state transitions on the low grid), is designated abstract reward:

$${r}_{z} ( z , {z}^{′} ) = {\sum }_{t = {t}_{z}}^{{t}_{z ′}} {r}_{t} \qquad ( 3 )$$

Using the values ν from the value map and the layout information L̅, from a fine scale state s an improved (for further processing) low level state ζ_{π} for actor 205 and an improved (for further processing) low level state ζ_{c} for the critic 206 can be ascertained:

F_{π}(ν, L̅, s)=ζ_{π}

F_{c}(ν, L̅, s)=ζ_{c} (4)

The functions F_{π} and F_{c} first map the state s (with a corresponding function M) to an abstract state z:

M(s)=z (5)

Using the abstract state z and the layout information L, the control device 105 can ascertain feature layout neighborhood information of z, [symbol] _{L̅}(z) , i.e. the layout information in the neighborhood of z. The same can be done by control device 105 with the value map to ascertain value neighborhood information of z, [symbol] _{ν} (z) (which contains the values in the neighborhood of z). Here the neighborhood of a state is formed by the horizontally, vertically, and diagonally adjacent states (i.e. tiles in the representation of FIG. 1), as well as the state itself.

The value neighborhood information [symbol] _{ν} (z) is normalized by a normalizer 208 to form normalized value neighborhood information [symbol] _{ν̅}(z) normalized. This is done according to

$$\overline{v} ( z , {z}^{′} ) = \frac{v ( {z}^{′} ) - μ ( {𝒩}_{v} ( z ) )}{σ ( {𝒩}_{v} ( z ) )} , \qquad ( 6 )$$

[symbol]

_{ν̅}(z)={ν̅(z, z′)|∀z′ ϵ [symbol] (z)} (7)

Here μ and σ are the mean value and standard deviation of the values in the neighborhood, respectively.

By subtracting the mean and dividing by the standard deviation, actor 205 and critic 206 are trained on the relative values of the neighborhood instead of the absolute values. F_{π} sets the improved state for the actor ζ_{π} by concatenation of the normalized value neighborhood information [symbol] _{ν̅}(z) and the fine scale state s. F_{c} concatenates the feature layout neighborhood information [symbol] _{L̅}(z)the normalized value neighborhood information [symbol] _{ν̅}(z) and the fine-scale state s. The improved state thus obtained for the critic ζ_{c} is fed to the critic 206 to approximate the Q-function, and the improved state for the actor ζ_{π} is used by the actor 205 to select actions. After each action (leading to a fine-scale state transition), an information tuple (L̅, s, a, r, s′, d) of layout information, fine-scale state, action, reward, next fine-scale state (i.e. fine-scale successor state), and the information whether the control pass ends with this transition, is stored in a

replay buffer 208 for the fine-scale states, which is designated by Bₛ. The successor state s′ results here from the interaction of the action a with the environment 210.

Different losses are used to train the propagation network 202, the actor 205, and the critic 206. In the following, we assume that double-Q learning is used for the critic and therefore there are two critic networks with two critic losses L_{critic}_{₁} and L_{critic}_{₂}. The losses for the actor L_{actor} and the critic losses use the improved states ζ_{π} and ζ_{c}.

$${ℒ}_{actor} = \frac{1}{\vert B \vert} {\sum }_{( \overline{L} , s , a , r , {s}^{′} , d ) ∈ B \sim {ℬ}_{s}} - {Q}_{{θ}_{1}} ( {F}_{c} ( {Φ}_{ϕ} ( D ( \overline{L} ) ) , s , \overline{L} ) , \\ {μ}_{ψ} ( {F}_{π} ( {Φ}_{ϕ} ( D ( \overline{L} ) ) , s , \overline{L} ) ) ) \qquad ( 8 )$$

$${ℒ}_{{critic}_{1}} = \frac{1}{\vert B \vert} {\sum }_{( \overline{L} , s , a , r , {s}^{′} , d ) ∈ B \sim {ℬ}_{s}} {( {Q}_{{θ}_{1}} ( {F}_{c} ( {Φ}_{ϕ} ( D ( \overline{L} ) ) , \\ s , \overline{L} ) , a ) - y ( r , {s}^{′} , d , \overline{L} ) )}^{2} \qquad ( 9 )$$

$${ℒ}_{{critic}_{2}} = \frac{1}{\vert B \vert} {\sum }_{( \overline{L} , s , a , r , {s}^{′} , d ) ∈ B \sim {ℬ}_{s}} {( {Q}_{{θ}_{2}} ( {F}_{c} ( {Φ}_{ϕ} ( D ( \overline{L} ) ) , s , \overline{L} ) , \\ a ) - y ( r , {s}^{′} , d , \overline{L} ) )}^{2} \qquad ( 10 )$$

Here Φ_{ϕ} designates the (trainable) mapping from L̅_{ƒ} to the value map 204 and the following holds:

$$y ( r , {s}^{′} , d , \overline{L} ) = r + γ ( 1 - d ) \cdot {min}_{i = 1 , 2} {Q}_{{θ}_{i}} ( {F}_{c} ( {Φ}_{ϕ} ( D ( \overline{L} ) ) , {s}^{′} , \overline{L} ) , \\ {μ}_{ψ} ( {F}_{π} ( {F}_{π} ( {Φ}_{ϕ} ( D ( L ) ) , {s}^{′} , \overline{L} ) ) + ϵ ) \qquad ( 11 )$$

where, if target networks are used (i.e. two versions of the network per network, one being the destination (or target) network whose parameters follow those of the other), here the network parameters ψ, ϕ are those of the target networks. The corresponding parameters are marked with the index “target” in the following.

Another loss that is used is called MVProp auxiliary loss. It is a TD0 loss with respect to the abstract states and is given by

$${y}^{′} ( {r}_{z} , {z}^{′} , d , \overline{L} ) = {r}_{z} + γ ( 1 - d ) {{Φ}_{{ϕ}_{target}} ( D ( \overline{L} ) )}_{{z}^{′}} \\ {ℒ}_{MVProp} = \frac{1}{\vert B \vert} {\sum }_{( \overline{L} , z , {r}_{z} , {z}^{′} , d ) ∈ B \sim {ℬ}_{z}} {( {{Φ}_{ϕ} ( D ( \overline{L} ) )}_{z} - {y}^{′} ( {r}_{z} , {z}^{′} , d , \overline{L} ) )}^{2} \qquad ( 12 )$$

The networks are trained (i.e. the parameters θ, ψ, ϕ adjusted) such that these losses are minimized (for training batches B sampled from replay buffers 207, 209).

However, not all parameters need to be adjusted for each loss. In the following, four variants are described.

The first variant, referred to as CDPM-0 (CDPM: Continuous Differentiable Planning Module) minimizes each loss only over the parameters of the network to which the loss relates:

$${min}_{θ} {ℒ}_{critic} , {min}_{ψ} {ℒ}_{actor} , {min}_{ϕ} {ℒ}_{MVProp} \qquad ( 13 )$$

The second variant, referred to as CDPM actor, differs from CDPM-0 in that the parameters ϕ of the planning network 202 are also trained based on the actor loss:

$${min}_{θ} {ℒ}_{critic} , {min}_{ψ , ϕ} {ℒ}_{actor} , {min}_{ϕ} {ℒ}_{MVProp} \qquad ( 14 )$$

In contrast, in the third variant, referred to as CDPM critic, the parameters ϕ of the planning network 202 are also trained based on the critic loss:

$${min}_{θ , ϕ} {ℒ}_{critic} , {min}_{ψ} {ℒ}_{actor} , {min}_{ϕ} {ℒ}_{MVProp} \qquad ( 15 )$$

In the fourth variant, referred to as CDPM-B, the parameters ϕ of the planning network 202 are trained based on what is known as the MVProp loss, the actor loss, and the critic loss:

$${min}_{θ , ϕ} {ℒ}_{critic} , {min}_{ψ , ϕ} {ℒ}_{actor} , {min}_{ϕ} {ℒ}_{MVProp} \qquad ( 16 )$$

FIG. 2 shows the back-propagation paths for the different training variants. The path shown by the dashed line holds for all variants, the dotted path for CDPM actor and CDPM-B, and the dash-dotted path for CDPM critic and CDPM-B.

When using target networks, the parameters of the target networks are updated using the polyak mean value, for example. For example, the target planning network is updated according to

ϕ_{target}←τϕ+(1−τ)ϕ_{target}. (17)

When the agent implemented by control device 105 is initialized in an environment 101, it receives the layout information L and the abstract reward r_{z} is set to zero. The control device 105 then transforms the layout information L̅ into the split feature layout L̅_{ƒ} and uses this to determine the value map (with values v). The agent then observes a state s and maps it to the abstract state z. With ν, L̅ and s the control device generates with the function F_{π} the improved state for the actor ζ_{π}. The actor selects an action based on ζ_{π} (or an action is sampled using an exploration algorithm). The selected (or sampled) action is chosen and the reward r, the successor state s′ and the status d (i.e. whether a final state was reached or not) are observed. The corresponding transition tuple (L̅, s, a , r, s′, d) is stored in Bₛ. The reward is added to the abstract reward, i.e. r₂ updated through r₂+r. If the fine-scale successor state s′ corresponds to a different abstract state z′ from z, then the abstract transition tuple (L̅, z, r_{z}, z′, d) is stored in the abstract replay buffer B_{z} and the abstract reward r_{z} is set to zero. Then the state s′ becomes the current state s and this process is iteratively continued (i.e. an action is chosen again, etc.) until the control run (episode) reaches an end state (which can also be done by reaching a maximum number of iterations).

Algorithm 1 describes the generation of the training state transitions in pseudocode (with the standard English keywords if, for, while, return, not, end, etc.).

Algorithm 1

Input: L̅, ∈, v, r_{z}
Return: d
Observe s in the environment
z ← M(s)
if u ~ U(0,1) < ε
a ~ U(−max-action, max-action)
Else
a ← μ_{ψ}(F_{π}(v, s, L̅))
end if
Observe r, s′, d from the environment
Save (L̅, s, a, r, s′, d) in [symbol] ₛ
Store state transition information for HER
z′ ← M(s′), r_{z} ← r_{z} + r
if z ≠ z′
Save (L̅, z, r_{z}, z′, d) in [symbol] _{z}
Store transition information for HER
r_{z} ← 0
end if
Return d

Algorithm 2 describes the training in pseudocode (with the standard English keywords if, for, while etc.).

Algorithm 2

```
Initialize planning network and target planning network
Φ_{ϕ}, Φ_{ϕ}_{_{target}}
Initialize critic networks and actor network Q_{θ}_{₁}, Q_{θ}_{₂}, μ_{ψ}
Initialize target critic networks and target actor network
Q_{θ}_{₁}_{,target}, Q_{θ}_{₂}_{,target}, μ_{ψ,target}
Initialize replay buffer [symbol]  ₛ and [symbol]  _{z}
Set training parameters ϵₘᵢₙ, Δϵ, starting_ep, τ, η, max-action
ep ← 0
while training do
Get new environment
L̅ ← get_environment_layout
v ← Φ_{ϕ} ((D(L̅))), r_{z} ← 0
if ep < starting_ep:
ϵ = 1
else:
ϵ = max(ϵₘᵢₙ, 1 − Δϵ * (ep − starting_ep))
end if
t ← 0, d ← False
while (not d) and (t < T) do
d ← create_training state transition (L̅, ϵ, v, r_{z}) //according
to algorithm 1
if time to train do
  (L̅_{b}, z, r_{z}, z′, d) ← B~B_{z}
  y′ ← r_{z} + (1 − d)Φ_{ϕ}_{_{target}}(L̅_{b})_{z′}
  $ϕ ← ϕ - η {∇}_{ϕ} \frac{1}{\vert B \vert} \sum {( {{Φ}_{ϕ} ( {\overline{L}}_{b} )}_{z} - {y}^{′} )}^{2}$
  (L̅_{b}, s, a, r, s′, d) ← B~ [symbol]  ₛ
  v_{b} ← Φ_{ϕ}(L̅_{b}), v′_{b} ← Φ_{ϕ}_{_{target}}(L̅_{b})
    a′ ← clip(μ_{ψ}_{_{target}}(F_{π}(v′_{b}, s′, L̅_{b})) + clip( [symbol] |(0, 0.1), −c, c) −max-a,
  max-a)
  y ← r + γ(1 − d) min_{i=1,2} Q_{θ}_{_{i,target}}(F_{c}(v′_{b}, s′, L̅_{b}), a′)
  ${θ}_{i} ← {θ}_{i} - η {∇}_{{θ}_{i}} \frac{1}{\vert B \vert} \sum {( {Q}_{{θ}_{i}} ( {F}_{c} ( {v}_{b} , s , {\overline{L}}_{b} ) , a ) - y )}^{2}$
  if update time mod 2 == 0 then
  $ψ ← ψ + η {∇}_{ψ} \frac{1}{\vert B \vert} \sum {Q}_{{θ}_{i}} ( {F}_{c} ( {v}_{b} , s , {\overline{L}}_{b} ) , {μ}_{ψ} ( {F}_{π} ( {v}_{b} , s , {\overline{L}}_{b} ) ) )$
  θ_{target} ← τθ + (1 − τ)θ_{target}
  ψ_{target} ← τψ + (1 − τ)ψ_{target}
  ϕ_{target} ← τϕ + (1 − τ)ϕ_{target}
end if
end if
t ← t + 1
end while
Add HER transitions for current episode ep to the buffers [symbol]
ₛ and [symbol]  _{z} to
ep ← ep + 1
end while
```

In the above example, HER (Hindsight Experience Replay) is used. This refers to a technique in which the identifier of a target state is changed so that the agent can learn from control runs in which the target state was not reached. This is optional.

In the use of the trained agent, the processing takes place analogously to the training. However, the critic 206 is then no longer used and no exploration takes place (i.e. the actions are always those selected by the (trained) actor 205).

As described above, the architecture of FIG. 2 is for example based on MVProp as planning module 201.

Compared to MVProp, according to one embodiment the original off-policy actor-critic RL algorithm using importance weighting is replaced by the off-policy actor-critic TD3 algorithm described in reference 2. This further improves the training compared to MVProp.

In addition, as described above, an additional auxiliary loss (denoted in the above example by L_{MVProp}) is used directly for the planning module 201, whose value is a function only of the output of the network 202 that outputs the propagation factors (i.e. the outputs of the other networks do not enter into this loss)

In addition, MVProp is adapted to use it with continuous states and continuous actions, in that
The (continuous) environment 101 is discretized into a coarse, discrete map representation that is used as input to the planning module 201
Continuous state information (exact position, speed, . . . that was not used by planning module 201) is added to the sections of the value map before being processed by actor 205 and critic 206.
An actor 205 (neural actor network) is used for the selection of continuous actions instead of an Argmax selection based on a value map neighborhood.

Moreover, according to various embodiments, the representations of inputs of the neural networks are adjusted:
In the case of different terrain types in the environment 101, each is assigned an individual binary channel (e.g. for a bitmap as described above) of the input of the propagation network 202.
The extracts (referred to above as “neighborhoods”) from the value map are normalized by a normalizer 208 using a z-score normalization.

These adjustments improve the performance (success rate) for specific application scenarios. For example, encoding the environment according to different terrain types (i.e. using different channels for different terrain types) improves the performance in application scenarios with multiple terrain types compared to using a single channel in which different terrain types are simply assigned different integers. Normalization improves generalization when applied to larger environments (layouts) than those that occur in training.

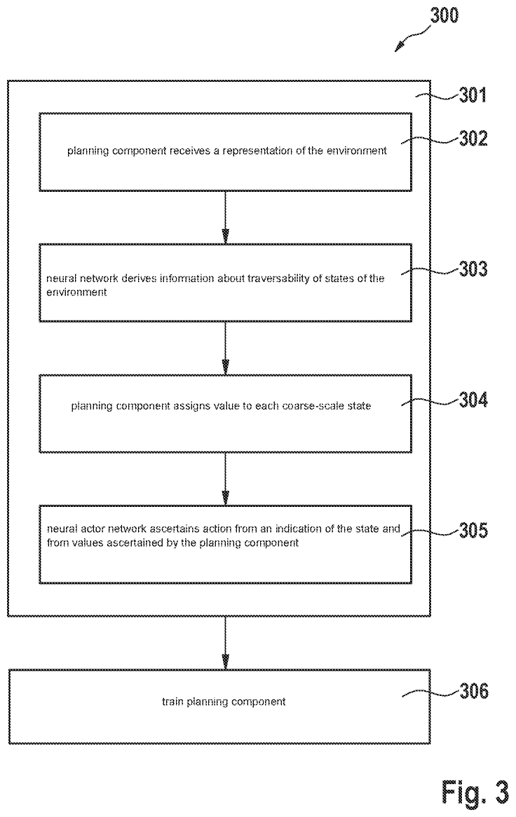

In summary, according to various embodiments, a method is provided as shown in FIG. 3.

FIG. 3 shows a flowchart 300 illustrating a method for training an agent according to one embodiment.

In 301, a plurality of control passes are performed, where, in each control pass,
in 302 a planning component receives a representation of an environment that includes layout information about the environment, the environment being divided into coarse-scale states according to a grid of coarse-scale states, such that each state that can be taken in the environment is in a coarse-scale state together with a plurality of other states that can be taken in the environment;
in 303 a neural network of the planning component derives information about the traversability of states in the environment from the representation of the environment,
in 304, the planning component assigns a value to each coarse-scale state based on the information about the traversability and preliminary reward information for the coarse-scale state to the coarse-scale state (wherein these values are normalized according to one embodiment); and
in 305, in each of a plurality of states reached in the environment by the agent, a neural actor network ascertains an action from an indication of the state and from values ascertained by the planning component for coarse-scale states in a neighborhood that contains the coarse-scale state in which the state is located and the coarse-scale states adjacent thereto.

In 306, the planning component is trained to reduce a loss (i.e. adjusted to reduce the loss) that includes, for each of a plurality of coarse-scale state transitions from a coarse-scale state to a coarse-scale successor state caused by the determined actions, an auxiliary loss that represents (or includes) a deviation between a value output by the planning component for the coarse-scale state and the sum of a reward received for the coarse-scale state transition and at least a portion of the value of the coarse-scale successor state.

According to one embodiment, a plurality of control passes are performed, wherein in each control pass
a planning component receives a representation of an environment that includes layout information about the environment, the environment being divided into coarse-scale states according to a grid of coarse-scale states, such that each state that can be taken in the environment is in a coarse-scale state together with a plurality of other states that can be taken in the environment;
a neural network of the planning component derives information about the traversability of states in the environment from the representation of the environment,
the planning component assigns a value to each coarse-scale state based on the traversability information and preliminary reward information for the coarse-scale state; and
starting from an initial state, the agent interacts with the environment and adjusts the parameters of its planning component and actor and critic networks for a specified time horizon or until the control task is successfully completed (e.g. a target state is reached); and
   based on the current state and on the values determined and subsequently normalized by the planning component for coarse-scale states in a neighborhood made up of the coarse-scale state in which the state is located and the coarse-scale states adjacent thereto, a neural actor network ascertains an action in place of which a random action can also be generated for exploration purposes during the training; and
   this action is performed, and as a result the state changes to a successor state, a reward is generated, and if appropriate it is determined whether the control task has already been completed; and
   the tuple, defining the state transition, of environment representation, state, action, reward, successor state, and information about successful completion of the control task is stored in a state transition memory; and
   in case of a change of the coarse-scale state, the state, or successor state, is assigned, the tuple defining this coarse-scale state transition made up of environment representation, coarse-scale state, coarse-scale reward, coarse-scale successor state and information about successful completion of the control task is stored in a coarse-scale state transition memory; and
   at defined time steps, the parameters of planning component and actor and critic networks are adjusted based on (portions of) the contents of the state transition memory and the coarse-scale state transition memory, the planning component, in particular, being trained to reduce a loss (i.e. adjusted to reduce the loss) that includes, for each of a plurality of coarse-scale state transitions from a coarse-scale state to a coarse-scale successor state, an auxiliary loss that includes a deviation between a value outputted by the planning component for the coarse-scale state and the sum of a reward received for the coarse-scale state transition and at least a portion of the value of the coarse-scale successor state, optionally taking into account, in addition to this auxiliary loss, losses with respect to the quality of the critic network and/or with respect to the performance of the controlling by the actions outputted by the actor network for training the planning component; and
optionally, if HER is used, (coarse-scale) transition tuples adjusted corresponding to HER for the terminated control pass are added to the state transition memory as well as to the coarse-scale state transition memory.

The method of FIG. 3 may be carried out by one or more computers with one or more data processing units. The term “data processing unit” can be understood as any type of entity that enables the processing of data or signals. For example, the data or signals may be handled according to at least one (i.e. one or more than one) specific function performed by the data processing unit. A data processing unit may include or be formed by an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA), or any combination thereof. Any other manner of implementing the respective functions described in more detail herein can also be understood as a data processing unit or logic circuit system. One or more of the method steps described in detail herein can be performed (e.g. implemented) by a data processing unit through one or more specific functions performed by the data processing unit.

Thus, according to various embodiments, the method is in particular computer-implemented.

For example, the approach of FIG. 3 is used to generate a control signal for a robotic device (i.e., the agent may be a controller for the robotic device or the robotic device itself). The term “robotic device” can be understood as referring to any technical system (having a mechanical part whose movement is controlled), such as a computer-controlled machine, a vehicle, a household appliance, a power tool, a manufacturing machine, a personal assistant, or an access control system. For example, a control rule for the technical system is learned (i.e. an agent is trained) and the technical system is then controlled accordingly.

Various embodiments can receive and use sensor signals from various sensors such as video, radar, lidar, ultrasound, motion, thermal imaging, etc., for example to obtain sensor data regarding states and configurations and scenarios (including the layout of the environment, i.e. layout information). The sensor data can be processed. This can include classifying the sensor data or carrying out a semantic segmentation on the sensor data, for example in order to detect the presence of objects (in the environment in which the sensor data were obtained). Embodiments can be used to train a machine learning system and to control a robot, e.g. autonomous robotic manipulators, in order to achieve different manipulation tasks in different scenarios. In particular, embodiments are applicable to controlling and monitoring the execution of manipulation tasks, e.g. in assembly lines.

Although specific embodiments have been shown and described herein, it will be recognized by those skilled in the art that the specific embodiments shown and described herein may be exchanged for a variety of alternative and/or equivalent implementations without departing from the scope of protection of the present invention. The present application is intended to cover any adaptations or variations of the specific embodiments discussed herein.

What is claimed is:

1. A method for training an agent, comprising the following steps:
performing multiple control passes, each of the control passes including:
receiving, by a planning component, a representation of an environment that contains layout information about the environment, the environment being divided into coarse-scale states according to a grid of coarse-scale states, so that each state that can be taken in the environment is in a coarse-scale state together with a plurality of other states that can be taken in the environment,
deriving, by a neural network of the planning component, information about the traversability of the states in the environment from the representation of the environment,
assigning, by the planning component, a value to each coarse-scale state based on the information about the traversability and preliminary reward information for the coarse-scale state, and
ascertaining, by a neural actor network in each of a plurality of states reached in the environment by the agent, an action from an indication of the state and from values ascertained by the planning component for the coarse-scale states in a neighborhood that contains the coarse-scale state in which the state is located and the coarse-scale states adjacent thereto; and
training the planning component to reduce an auxiliary loss that includes, for each of a plurality of coarse-scale state transitions from a coarse-scale state to a coarse-scale successor state caused by the ascertained actions, an auxiliary loss that represents a deviation between the value outputted by the planning component for the coarse-scale state and a sum of a reward received for the coarse-scale state transition and at least a portion of the value of the coarse-scale successor state.

2. The method as recited in claim 1, wherein the planning component is trained to reduce an overall loss that includes, in addition to the auxiliary loss, an actor loss that penalizes when the neural actor network selects actions that a critic network gives a low evaluation.

3. The method as recited in claim 1, wherein the planning component is trained to reduce an overall loss, which in addition to the auxiliary loss includes a critic loss that penalizes deviations of evaluations, provided by a critic network, of state-action pairs from evaluations that include sums of the rewards actually obtained by performing the actions of the state-action pairs in the states of the state-action pairs, and discounted evaluations, provided by a critic network, of successor state-successor action pairs, the successor actions to be used for the successor states being determined using the actor network for the successor states.

4. The method as recited in claim 1, the planning component being trained to reduce an overall loss that includes, in addition to the auxiliary loss, an actor loss that penalizes when the neural actor network selects actions that a critic network gives a low evaluation, and a critic loss that penalizes deviations of evaluations, provided by a critic network, of state-action pairs from evaluations that include sums of the rewards actually obtained by performing the actions of the state-action pairs in the states of the state-action pairs, and discounted evaluations, provided by a critic network, of successor state-successor action pairs, the successor actions to be used for the successor states being determined with the aid of the actor network for the successor states.

5. The method as recited in claim 1, wherein the layout information includes information about a location of different terrain types in the environment and the representation includes, for each terrain type, a map with binary types indicating, for each of a plurality of locations in the environment, whether the terrain type is present at the location.

6. The method as recited in claim 1, wherein the values ascertained by the planning component for the neighborhood of coarse-scale states are normalized with respect to a mean value of the ascertained values and a standard deviation of the ascertained values.

7. A control device configured to train an agent, the control device being configured to:
perform multiple control passes, each of the control passes including:
receiving, by a planning component, a representation of an environment that contains layout information about the environment, the environment being divided into coarse-scale states according to a grid of coarse-scale states, so that each state that can be taken in the environment is in a coarse-scale state together with a plurality of other states that can be taken in the environment,
deriving, by a neural network of the planning component, information about the traversability of the states in the environment from the representation of the environment,
assigning, by the planning component, a value to each coarse-scale state based on the information about the traversability and preliminary reward information for the coarse-scale state, and
ascertaining, by a neural actor network in each of a plurality of states reached in the environment by the agent, an action from an indication of the state and from values ascertained by the planning component for the coarse-scale states in a neighborhood that contains the coarse-scale state in which the state is located and the coarse-scale states adjacent thereto; and
train the planning component to reduce an auxiliary loss that includes, for each of a plurality of coarse-scale state transitions from a coarse-scale state to a coarse-scale successor state caused by the ascertained actions, an auxiliary loss that represents a deviation between the value outputted by the planning component for the coarse-scale state and a sum of a reward received for the coarse-scale state transition and at least a portion of the value of the coarse-scale successor state.

8. A non-transitory computer-readable medium on which is stored a computer program including instructions for training an agent, the instructions, when executed by a processor, causing the processor to perform the following steps:
performing multiple control passes, each of the control passes including:
receiving, by a planning component, a representation of an environment that contains layout information about the environment, the environment being divided into coarse-scale states according to a grid of coarse-scale states, so that each state that can be taken in the environment is in a coarse-scale state together with a plurality of other states that can be taken in the environment,
deriving, by a neural network of the planning component, information about the traversability of the states in the environment from the representation of the environment,
assigning, by the planning component, a value to each coarse-scale state based on the information about the traversability and preliminary reward information for the coarse-scale state, and
ascertaining, by a neural actor network in each of a plurality of states reached in the environment by the agent, an action from an indication of the state and from values ascertained by the planning component for the coarse-scale states in a neighborhood that contains the coarse-scale state in which the state is located and the coarse-scale states adjacent thereto; and
training the planning component to reduce an auxiliary loss that includes, for each of a plurality of coarse-scale state transitions from a coarse-scale state to a coarse-scale successor state caused by the ascertained actions, an auxiliary loss that represents a deviation between the value outputted by the planning component for the coarse-scale state and a sum of a reward received for the coarse-scale state transition and at least a portion of the value of the coarse-scale successor state.
